(19) United States
(12) Patent Application Publication
(10) Pub. No.: US 2026/0331405 A1
(43) Pub. Date: Oct. 22, 2026

(54) MINIATURE CIRCUIT BREAKER

(71) Applicant: Schneider Electric Industries SAS, Rueil-Malmaison (FR)

(72) Inventors: Gang YU, Shanghai (CN); Zhenzhong LIU, Shanghai (CN); Simon TIAN, Shanghai (CN); Meng ZHANG, Shanghai (CN)

(21) Appl. No.: 19/645,602

(22) Filed: Apr. 13, 2026

(30) Foreign Application Priority Data
Apr. 21, 2025 (CN) 2025105034303

(51) Int. Cl. H01H 73/18; H01H 73/04; H01H 73/06; H01H 73/20; H01H 73/36

(52) U.S. Cl. CPC H01H 73/18; H01H 73/045; H01H 73/06; H01H 73/20; H01H 73/36

(57) ABSTRACT

Disclosed embodiments include a miniature circuit breaker that adopts a double breaking point design, which can increase the arc voltage, and has excellent current limiting capability and high short-circuit breaking performance. Some embodiments include a clapper-type electromagnet to realize magnetic tripping, which can not only drive the movable iron core to trigger the tripping of the miniature circuit breaker through the clapper magnetic circuit to cut off the short-circuit current, making the protection of the miniature circuit breaker more reliable, but also drive the electric arc generated when the moving and stationary contacts are separated to move rapidly toward the arc extinguishing chamber through the arc-blowing magnetic circuit, improving the breaking capacity of the miniature circuit breaker.

### CROSS-REFERENCE

This application claims priority to Chinese Patent Application No. 2025105034303, filed on Apr. 21, 2025, and entitled “MINIATURE CIRCUIT BREAKER”, the entirety of which is incorporated herein by reference.

### TECHNICAL FIELD

The present disclosure relates to a miniature circuit breaker.

### BACKGROUND

A miniature circuit breaker is a switch for connecting, carrying and breaking current. The miniature circuit breaker can automatically open in the event of an overload or short circuit in a circuit, thereby providing protection for the circuit and equipment.

Traditional miniature circuit breakers have only a single breaking point, the space of the arc extinguishing chamber is limited, and the breaking capacity is insufficient, which cannot meet the product requirements for higher short-circuit breaking capacity. Therefore, it is necessary to design a miniature circuit breaker with higher short-circuit breaking capacity, so that the circuit can be cut off safely and quickly in case of a fault, avoiding equipment damage, fire or personal injury.

### SUMMARY

At least one embodiment of the present disclosure provides a miniature circuit breaker, including: a contact system, including a movable contact support and two contact groups, where each of the two contact groups includes a movable contact and a stationary contact, two movable contacts are arranged at intervals in a first direction and mounted on the movable contact support, and the movable contact support is configured to be movable in a second direction perpendicular to the first direction to make the movable contact contact with or separate from a corresponding stationary contact; a conductor group, including a first stationary contact conductor and a second stationary contact conductor, where the stationary contact of one of the two contact groups is arranged on the first stationary contact conductor, and the stationary contact of the other one of the two contact groups is arranged on the second stationary contact conductor; an arc extinguishing chamber configured to extinguish an electric arc generated by the two contact groups; a magnetic trip assembly, including a first stationary iron core and a movable iron core that form a clapper-type electromagnet with the first stationary contact conductor, where the first stationary contact conductor surrounds an outer side of the first stationary iron core, and the first stationary contact conductor is configured to form a first magnetic circuit and a second magnetic circuit with the first stationary iron core based on a current flowing through the first stationary contact conductor; when the current exceeds a threshold current, the movable iron core is driven by the first magnetic circuit and moves toward the first stationary iron core to drive the movable contact support to move; and the second magnetic circuit is configured to drive the electric arc to move toward the arc extinguishing chamber.

For example, in the miniature circuit breaker provided by at least one embodiment of the present disclosure, the arc extinguishing chamber includes two arc extinguishing sub-chambers, the two arc extinguishing sub-chambers are respectively located on two sides of the contact system in the first direction, each of the two arc extinguishing sub-chambers is configured to extinguish the electric arc generated by a corresponding contact group, and the second magnetic circuit is configured to drive the electric arc to move toward an arc extinguishing sub-chamber corresponding to the first stationary contact conductor.

For example, in the miniature circuit breaker provided by at least one embodiment of the present disclosure, each of the two arc extinguishing sub-chambers includes a plurality of arc extinguishing grids, the plurality of arc extinguishing grids are arranged at intervals from each other in the first direction and extend in a sheet shape in the second direction and a third direction, and the third direction is perpendicular to the first direction and the second direction.

For example, in the miniature circuit breaker provided by at least one embodiment of the present disclosure, the arc extinguishing chamber includes N arc extinguishing grids, where N is an integer and 6≤N≤30.

For example, the miniature circuit breaker provided by at least one embodiment of the present disclosure, further includes an operating mechanism, where the operating mechanism includes a trip bar, the movable contact support includes a support main body extending in the second direction, the support main body has a first end and a second end opposite to each other in the second direction, the movable contact support is configured to be movable along the second direction, and the movable contact is connected to the second end of the support main body, the first end of the support main body is operatively linked with the trip bar to enable the trip bar to rotate and move away from the support main body.

For example, in the miniature circuit breaker provided by at least one embodiment of the present disclosure, the movable iron core includes: a pivot end rotatably connected to the first stationary contact conductor, and a free movable end for driving the movable contact support to move; and a side surface of the support main body is provided with a through channel extending in the second direction, a through direction of the through channel is along the first direction, and the through channel is configured to allow the free movable end to be inserted therein, so that the free movable end, when driven to move toward the first stationary iron core, strikes the movable contact support to move.

For example, in the miniature circuit breaker provided by at least one embodiment of the present disclosure, the first end of the movable contact support includes a hook-shaped portion, the hook-shaped portion protrudes relative to a side surface of the support main body, and a hook opening of the hook-shaped portion faces the second end of the support main body; and the trip bar includes a hooked end, and the hooked end and the hook-shaped portion are configured such that, when the movable contact is in contact with the stationary contact, projections of he hooked end and the hook-shaped portion on a plane formed by the first direction and a third direction overlap at least partially, so that the hooked end is hooked by the hook-shaped portion when the support main body moves, thereby making the trip bar move away from the support main body, where the third direction is perpendicular to the first direction and the second direction.

For example, the miniature circuit breaker provided by at least one embodiment of the present disclosure, further includes a second stationary iron core, a first terminal and a second terminal, where one of the first terminal and the second terminal is an incoming terminal and the other one is an outgoing terminal, the first stationary contact conductor extends from the first terminal around the first stationary iron core to a corresponding arc extinguishing sub-chamber in the arc extinguishing chamber, the second stationary contact conductor surrounds an outer side of the second stationary iron core, where the second stationary contact conductor extends from the second terminal around the second stationary iron core to a corresponding arc extinguishing sub-chamber in the arc extinguishing chamber, and the first stationary iron core and the second stationary iron core are located on two sides of the movable contact support in the first direction, and the first stationary contact conductor and the second stationary contact conductor are respectively located on two sides of the movable contact support in the first direction.

For example, in the miniature circuit breaker provided by at least one embodiment of the present disclosure, the first stationary contact conductor includes a U-shaped conductive plate wound around the first stationary iron core, the U-shaped conductive plate includes: a first conductor segment, a second conductor segment and an intermediate conductor segment connecting the first conductor segment and the second conductor segment, the first conductor segment and the second conductor segment are respectively located on two sides of the first stationary iron core in the second direction, and an opening direction of the U-shaped conductive plate faces away from the movable contact support; and the pivot end is rotatably connected to the first conductor segment by a connecting shaft, the stationary contact is arranged on the second conductor segment, and a tail end of the second conductor segment away from the movable contact support corresponds to an outer end of the arc extinguishing sub-chamber.

For example, in the miniature circuit breaker provided by at least one embodiment of the present disclosure, the first stationary contact conductor further includes a third conductor segment connected to the tail end of the second conductor segment, and the third conductor segment extends from the tail end to the arc extinguishing sub-chamber and integrally extends along the second direction.

For example, in the miniature circuit breaker provided by at least one embodiment of the present disclosure, the first conductor segment is a straight bar extending in the first direction.

For example, in the miniature circuit breaker provided by at least one embodiment of the present disclosure, the first stationary contact conductor and/or the second stationary contact conductor are respectively integrally formed, and the first stationary contact conductor and the second stationary contact conductor have the same structure.

For example, in the miniature circuit breaker provided by at least one embodiment of the present disclosure, the first stationary iron core includes a plurality of separate iron core blocks arranged side by side in the first direction; and/or the second stationary iron core includes a plurality of separate iron core blocks arranged side by side in the first direction.

For example, in the miniature circuit breaker provided by at least one embodiment of the present disclosure, the clapper-type electromagnet further includes two first magnetic conductive blocks, the two first magnetic conductive blocks are respectively located on two sides of the first stationary contact conductor in a third direction, where the third direction is perpendicular to the first direction and the second direction; each of the two first magnetic conductive block includes a first magnetic conductive segment, a second magnetic conductive segment and an intermediate magnetic conductive segment connecting the first magnetic conductive segment and the second magnetic conductive segment, where the first magnetic conductive segment and the second magnetic conductive segment both extend in the first direction, and the intermediate magnetic conductive segment is located at an end of the first magnetic conductive block away from the movable contact support in the first direction; and the first magnetic conductive segment is attached to an end of the first stationary iron core away from the arc extinguishing chamber in the second direction, and the second magnetic conductive segment is attached to an end of the first stationary iron core close to the arc extinguishing chamber in the second direction.

For example, in the miniature circuit breaker provided by at least one embodiment of the present disclosure, a length of the second magnetic conductive segment in the first direction covers a corresponding arc extinguishing sub-chamber.

For example, the miniature circuit breaker provided by at least one embodiment of the present disclosure, further includes two second magnetic conductive blocks, where the two second magnetic conductive blocks are respectively located on two sides of the second stationary contact conductor in the third direction, and each of the two second magnetic conductive blocks and each of the two first magnetic conductive blocks have the same structure.

For example, in the miniature circuit breaker provided by at least one embodiment of the present disclosure, a total weight of the movable contact support and the two movable contacts is 2 g to 2.5 g.

For example, the miniature circuit breaker provided by at least one embodiment of the present disclosure, further includes a contact pressure spring, where one end of the contact pressure spring is connected to the movable contact support, the other end of the contact pressure spring is connected to the operating mechanism, and the contact pressure spring forms an overtravel gap with the first end of the movable contact support.

For example, the miniature circuit breaker provided by at least one embodiment of the present disclosure, further includes an electronic trip unit, where the electronic trip unit is configured to control movement of the movable contact support by sensing a current of the second stationary contact conductor to trigger tripping of the miniature circuit breaker.

### BRIEF DESCRIPTION OF DRAWINGS

In order to explain the embodiments of the present disclosure or the technical solutions in the prior art more clearly, the drawings required for describing the embodiments or the prior art will be briefly introduced below. Obviously, the drawings described below are only some embodiments of the present disclosure, and for those of ordinary skill in the art, other drawings can be obtained according to these drawings without creative work.

FIG. 1 is a structural schematic diagram of a miniature circuit breaker in a closed state according to some embodiments of the present disclosure.

FIG. 2 is a structural schematic diagram of a miniature circuit breaker in an open state according to some embodiments of the present disclosure.

FIG. 3 is a structural schematic diagram of a miniature circuit breaker in a closed state according to other embodiments of the present disclosure.

FIGS. 4-6 are partial schematic diagrams of a miniature circuit breaker according to some embodiments of the present disclosure.

FIG. 7 is a structural schematic diagram of a movable contact support according to some embodiments of the present disclosure.

FIG. 8 is a structural schematic diagram of a movable iron core according to some embodiments of the present disclosure.

FIG. 9 is a structural schematic diagram of a first stationary contact conductor according to some embodiments of the present disclosure.

FIG. 10 is a structural schematic diagram of a first magnetic conductive block according to some embodiments of the present disclosure.

FIG. 11 is a structural schematic diagram of a first stationary iron core according to some embodiments of the present disclosure.

### DETAILED DESCRIPTION

The technical solutions in the embodiments of the present disclosure will be clearly and completely described below in conjunction with the drawings in the embodiments of the present disclosure. Obviously, the described embodiments are only a part of the embodiments of the present disclosure, rather than all the embodiments. Based on the embodiments in the present disclosure, all other embodiments obtained by those of ordinary skill in the art without creative work shall fall within the protection scope of the present disclosure.

Unless otherwise defined, all terms (including technical and scientific terms) used in the embodiments of the present disclosure have the same meaning as commonly understood by those of ordinary skill in the art to which the present disclosure belongs. It should also be understood that terms such as those defined in ordinary dictionaries should be interpreted as having meanings consistent with their meanings in the context of the relevant technology, and should not be interpreted in an idealized or overly formal sense unless explicitly defined as such in the embodiments of the present disclosure.

The terms “first”, “second” and similar terms used in the embodiments of the present disclosure do not indicate any order, quantity or importance, but are only used to distinguish different components. The terms “a”, “an” or “the” and similar terms also do not indicate a quantity limit, but indicate the presence of at least one. Similarly, the terms “comprise” or “include” and similar terms mean that the element or object preceding the word covers the element or object listed after the word and its equivalents, without excluding other elements or objects. The terms “connect” or “couple” and similar terms are not limited to physical or mechanical connections, but may include electrical connections, whether direct or indirect. The terms “inner”, “outer”, “upper”, “lower” and the like are only used to indicate relative positional relationships, and when the absolute position of the described object changes, the relative positional relationship may also change accordingly. In the embodiments of the present disclosure, the term “about” used in the text means that the value is approximate and small changes will not significantly affect the practice of the aspects disclosed in the present disclosure, and the embodiments of the present disclosure do not have a specified numerical limit. The drawings in the present disclosure are not drawn in strict accordance with the actual scale, and the specific size and quantity of each structure can be determined according to actual needs. The drawings described in the present disclosure are only structural schematic diagrams.

In order to enable the miniature circuit breaker to achieve a high short-circuit breaking capacity (for example, a short-circuit breaking capacity of 50 KA), at least one embodiment of the present disclosure provides a miniature circuit breaker, including: a contact system including a movable contact support and two contact groups, where each of the two contact groups includes a movable contact and a stationary contact, two movable contacts are arranged at intervals in a first direction and mounted on the movable contact support, and the movable contact support is configured to be movable in a second direction perpendicular to the first direction to make the movable contact contact with or separate from a corresponding stationary contacts; a conductor group including a first stationary contact conductor and a second stationary contact conductor, where the stationary contact of one of the two contact groups is arranged on the first stationary contact conductor, and the stationary contact of the other one of the two contact groups is arranged on the second stationary contact conductor; an arc extinguishing chamber configured to extinguish an electric arc generated by the two contact groups; a magnetic trip assembly including a first stationary iron core and a movable iron core that form a clapper-type electromagnet with the first stationary contact conductor, where the first stationary contact conductor surrounds an outer side of the first stationary iron core, and the first stationary contact conductor is configured to form a first magnetic circuit and a second magnetic circuit with the first stationary iron core based on a current flowing through the first stationary contact conductor; when the current exceeds a threshold current, the movable iron core is driven by the first magnetic circuit and moves toward the first stationary iron core to drive the movable contact support to move; and the second magnetic circuit is configured to drive the electric arc to move toward the arc extinguishing chamber.

The miniature circuit breaker of the present disclosure adopts a double breaking point design, which can increase the arc voltage, and the miniature circuit breaker has excellent current limiting capability and high short-circuit breaking performance. The present disclosure adopts an ingeniously designed clapper-type electromagnet to realize magnetic tripping, which can not only drive the movable iron core to trigger the tripping of the miniature circuit breaker through the clapper magnetic circuit to cut off the short-circuit current, making the protection of the miniature circuit breaker more reliable, but also drive the electric arc generated when the moving and stationary contacts are separated to move rapidly toward the arc extinguishing chamber through the arc-blowing magnetic circuit, improving the breaking capacity of the miniature circuit breaker.

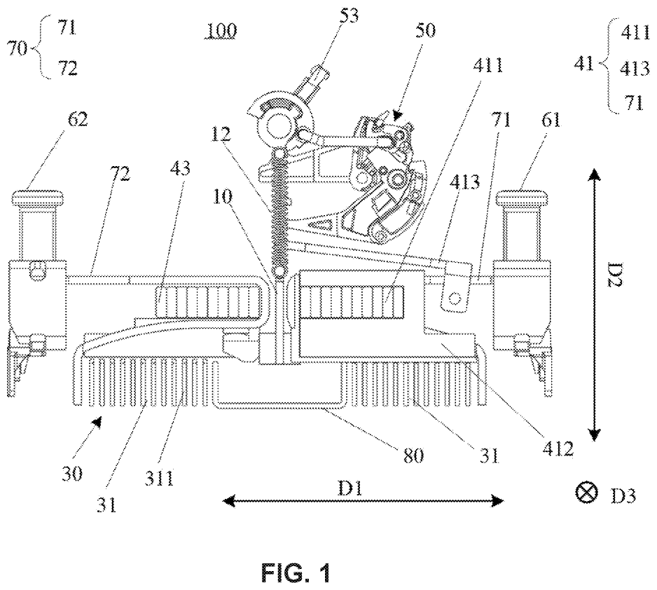

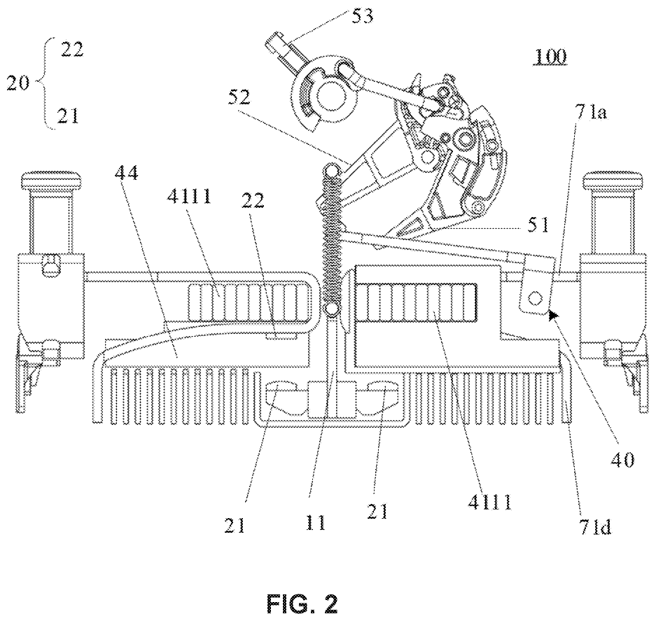

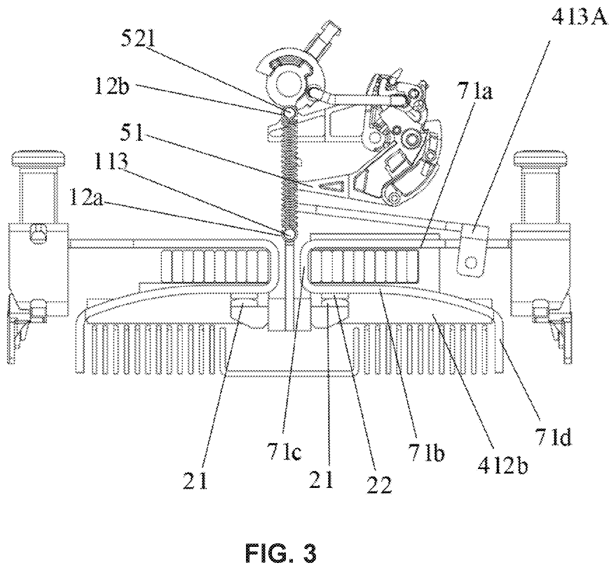

FIG. 1 is a structural schematic diagram of a miniature circuit breaker in a closed state according to some embodiments of the present disclosure. FIG. 2 is a structural schematic diagram of a miniature circuit breaker in an open state according to some embodiments of the present disclosure. FIG. 3 is a structural schematic diagram of a miniature circuit breaker in a closed state according to other embodiments of the present disclosure, where FIG. 3 illustrates some features not shown in FIG. 1 and adds different numerical references compared to FIG. 1.

For example, as shown in FIGS. 1 and 2, the miniature circuit breaker 100 according to at least one embodiment of the present disclosure includes a contact system, a conductor group 70, an arc extinguishing chamber 30 and a magnetic trip assembly 40.

The contact system includes a movable contact support 10 and two contact groups 20. Each contact group 20 includes a movable contact 21 and a stationary contact 22, and the two movable contacts 21 are arranged at intervals in a first direction D1 and mounted on the movable contact support 10.

The conductor group 70 includes a first stationary contact conductor 71 and a second stationary contact conductor 72, where the stationary contact 22 of one of the two contact groups 20 is arranged on the first stationary contact conductor 71, and the stationary contact 22 of the other one of the two contact groups 20 is arranged on the second stationary contact conductor 72.

The movable contact support 10 is configured to be movable in a second direction D2 to make the movable contact 21 contact with or separate from a corresponding stationary contact 22, where the second direction D2 is perpendicular to the first direction D1. The arc extinguishing chamber 30 is configured to extinguish an electric arc generated by the contact group 20.

A direction perpendicular to both the first direction D1 and the second direction D2 is defined as a third direction D3 in the embodiments of the present disclosure. In the embodiments of the present disclosure, the first direction D1 is not specifically limited to the horizontal direction, and the second direction D2 is not specifically limited to the gravity direction, as long as the two contact groups 20 are arranged at intervals along one direction and the second direction is perpendicular to this direction, which will not limit the embodiments of the present disclosure.

For example, as shown in FIGS. 1 and 2, the movable contacts 21 on the movable contact support 10 can approach or move away from the stationary contacts 22 with the movement of the movable contact support 10, so that the movable contacts 21 can abut against or separate from the corresponding stationary contacts 22. As shown in FIG. 1, when the miniature circuit breaker 100 is in a closed state, the movable contacts 21 are in contact with the corresponding stationary contacts 22. As shown in FIG. 2, when the miniature circuit breaker 100 is in an open state, the movable contacts 21 are separated from the corresponding stationary contacts 22. The electric arc generated when the movable contacts 21 and the stationary contacts 22 are separated can be introduced into the arc extinguishing chamber 30 to be extinguished.

For example, as shown in FIG. 1, the miniature circuit breaker 100 further includes two terminals, denoted as a first terminal 61 and a second terminal 62 respectively, where either one of the first terminal 61 and the second terminal 62 is an incoming terminal and the other one is an outgoing terminal, the incoming terminal is used for connecting a power supply, and the outgoing terminal is used for connecting a load. In the embodiments of the present disclosure, the first direction D1 is parallel to an extending direction between the first terminal 61 and the second terminal 62. For example, the stationary contact 22 on the first stationary contact conductor 71 is electrically connected to the first terminal 61, and the stationary contact 22 on the second stationary contact conductor 72 is electrically connected to the second terminal 62.

For example, when the movable contacts 21 are in contact with the corresponding stationary contacts 22, a conducting loop (also referred to as the main circuit of the miniature circuit breaker 100) is formed by the first terminal 61, the second terminal 62, and the path between them including the first stationary contact conductor 71, the stationary contact 22 (which may be referred to as the first stationary contact) on the first stationary contact conductor 71, the movable contact 21 (which may be referred to as the first movable contact) corresponding to the first stationary contact, the other movable contact 21 (which may be referred to as the second movable contact), the stationary contact (which may be referred to as the second stationary contact) on the second stationary contact conductor 72, and the second stationary contact conductor 72. For example, when the movable contacts 21 are separated from the corresponding stationary contacts 22, the main circuit of the miniature circuit breaker 100 is disconnected.

For example, as shown in FIGS. 1 and 2, the magnetic trip assembly 40 includes a first stationary iron core 411 and a movable iron core 413 that form a clapper-type electromagnet 41 with the first stationary contact conductor 71. The first stationary contact conductor 71 surrounds an outer side of the first stationary iron core 411, and the first stationary contact conductor 71 is configured to form a first magnetic circuit and a second magnetic circuit with the first stationary iron core 411 based on a current flowing through the first stationary contact conductor 71. When the current exceeds a threshold current (i.e., the main circuit current of the miniature circuit breaker 100 exceeds the threshold current), the movable iron core 413 is driven by the first magnetic circuit and moves toward the first stationary iron core 411 to drive the movable contact support 20 to move. The second magnetic circuit is configured to drive the electric arc to move toward the arc extinguishing chamber 30.

In some examples, when the main circuit current passing through the miniature circuit breaker 100 is greater than a first preset current threshold I1 (i.e., the threshold current mentioned above is this first preset current threshold I1), the movable iron core 413 is driven by the first magnetic circuit to move toward the first stationary iron core 411, thereby driving the movable contact support 20 to move downward, so that the movable contacts 21 are separated from the corresponding stationary contacts 22. For example, the first preset current threshold I1 is a short-circuit current threshold. Therefore, in the embodiment of the present disclosure, the magnetic trip assembly 40 can break the short-circuit current.

The miniature circuit breaker of the present disclosure adopts a double breaking point design, which can increase the arc voltage, and the miniature circuit breaker has excellent current limiting capability and high short-circuit breaking performance. For example, the embodiments of the present disclosure can safely break a fault with an expected short-circuit current of 50 KA. The present disclosure also adopts an ingeniously designed clapper-type electromagnet to realize magnetic tripping, which can divide the magnetic field generated by electricity into two parts, not only can drive the movable iron core to trigger the tripping of the miniature circuit breaker through the clapper magnetic circuit to cut off the short-circuit current, making the protection of the miniature circuit breaker more reliable, but also can drive the electric arc generated when the moving and stationary contacts are separated to move rapidly toward the arc extinguishing chamber through the arc-blowing magnetic circuit, extinguish the electric arc quickly and control the electric arc effectively, improving the breaking capacity of the miniature circuit breaker. The miniature circuit breaker of the embodiments of the present disclosure also has the advantages of a reduced number of parts, simple structure and convenient assembly.

The embodiments of the present disclosure do not limit the above-mentioned first preset current threshold I1, which may be, but is not limited to, 1 kA, 5 kA, 10 kA, 20 KA and the like. It can be understood that the first preset current threshold I1 may also be other values according to different application environments of the miniature circuit breaker, for example, it may also be less than 1 kA, which will not be exhausted and described in detail here.

It should be noted that the terms “upper” and “lower” in the embodiments of the present disclosure refer to the drawing directions for the convenience of description, not specifically limited to the gravity direction, and the terms “left” and “right” in the embodiments of the present disclosure refer to the drawing directions for the convenience of description, not specifically limited to the horizontal direction, and the protection scope of the present disclosure is not affected thereby.

In some examples, the miniature circuit breaker 100 further includes an electronic trip unit (not shown), which is configured to control movement of the movable contact support 10 by sensing a current of the second stationary contact conductor 72 to trigger tripping of the miniature circuit breaker 100. For example, the electronic trip unit measures the magnitude of the main circuit current of the miniature circuit breaker 100 by sensing the current, so that the controller in the electronic trip unit performs corresponding control to determine whether to actuate the movable contact support 11.

In some examples, when the main circuit current of the miniature circuit breaker 100 is greater than a second preset current threshold I2, the movable contact support 10 is driven to move by the electronic trip unit, so that the main circuit current is automatically broken. For example, the second preset current threshold I2 is less than the first preset current threshold I1.

Exemplarily, the second preset current threshold I2 may be an overload current threshold. Therefore, the electronic trip unit 40 can break the overload current.

Further exemplarily, the second preset current threshold I2 may also be a third preset short-circuit current threshold I3 between the overload current threshold and the first preset current threshold I1. Therefore, the electronic trip unit 40 can also be used to break the short-circuit current of relatively lower magnitude. The above-mentioned first preset current threshold I1 is a relatively high short-circuit current relative to the third preset short-circuit current threshold I3.

The miniature circuit breaker of some embodiments of the present disclosure may not need to use a thermal trip unit with a bimetallic strip. The miniature circuit breaker provided in some embodiments of the present disclosure realizes overload protection and short-circuit protection through the combination of a magnetic trip assembly and an electronic trip unit, which allows the magnetic trip assembly to focus on quickly breaking a relatively high short-circuit current without considering the constraint of a relatively low short-circuit current, and allows the electronic trip unit to meet the breaking requirements of overload current and low short-circuit current by using low-cost components. In some embodiments, the structure and composition of the electronic trip unit are not the focus of the embodiments of the present disclosure, and will not be described in detail herein. Of course, this is only exemplary, and the embodiments of the present disclosure may be a miniature circuit breaker without an electronic trip unit, and the embodiments of the present disclosure are not limited thereto and can be freely adjusted according to actual conditions.

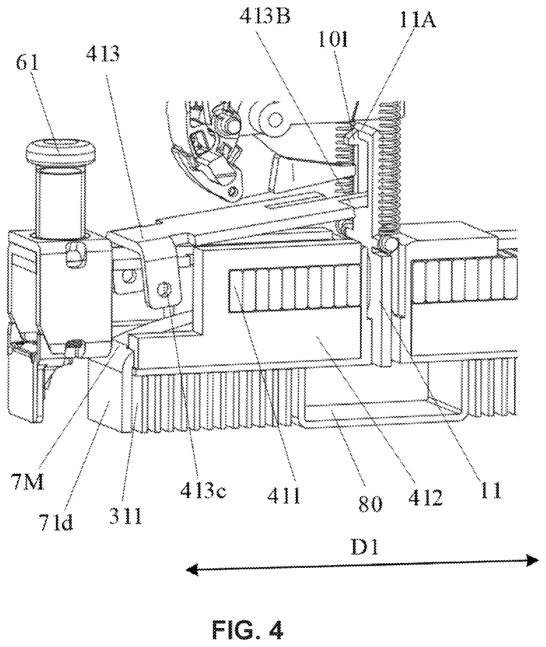

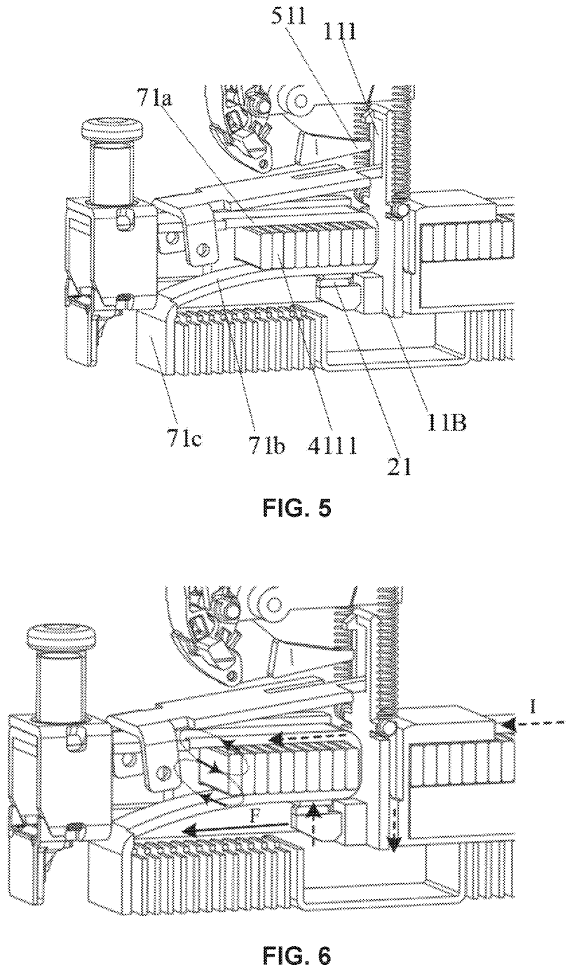

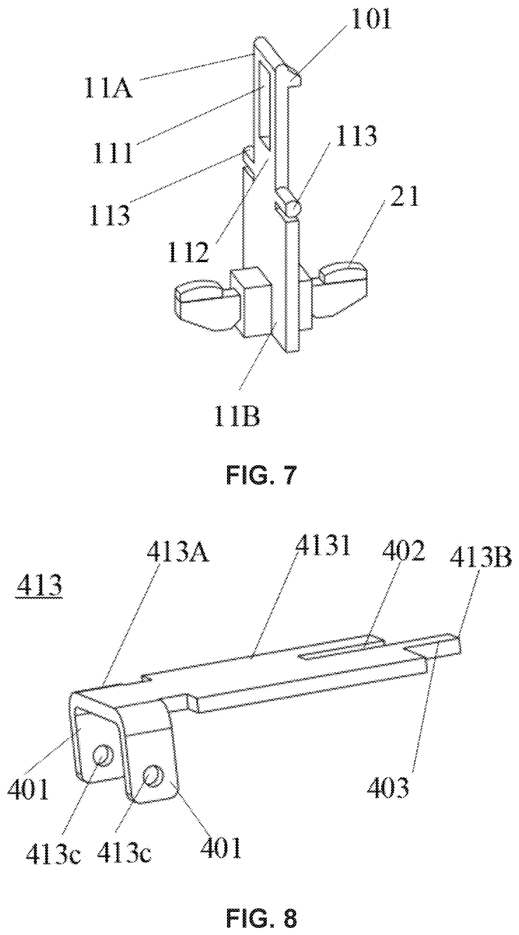

FIGS. 4-6 are partial schematic diagrams of a miniature circuit breaker according to some embodiments of the present disclosure. FIG. 5 shows some features not shown in FIG. 4 and has different reference numerals from FIG. 4, and FIG. 6 is the same drawing as FIG. 5 but with different reference numerals. FIG. 7 is a structural schematic diagram of a movable contact support according to some embodiments of the present disclosure.

For example, as shown in FIG. 1, the arc extinguishing chamber 30 includes two arc extinguishing sub-chambers 31, the two arc extinguishing sub-chambers 31 are respectively located on two sides of the contact system in the first direction D1, and each arc extinguishing sub-chamber 31 is configured to extinguish the electric arc generated by a corresponding contact group 20. For example, the second magnetic circuit generated by the clapper-type electromagnet 41 is configured to drive the electric arc to move toward the arc extinguishing sub-chamber 31 corresponding to the first stationary contact conductor 71.

The embodiments of the present disclosure adopt a double breaking point and double arc extinguishing chamber design, which increases the arc voltage, can open the movable contacts as early and quickly as possible, and has excellent current limiting capability and high breaking performance.

In some embodiments of the present disclosure, the first magnetic circuit and the second magnetic circuit are two magnetic loops generated by the current flowing in the first stationary contact conductor 71 through electromagnetic induction in cooperation with the first stationary iron core 411. The movable iron core 413 of the clapper-type electromagnet 41 is magnetized by the first magnetic circuit, so that an attractive force is generated between the movable iron core 413 and the first stationary iron core 411, and the movable iron core 413 is driven to rotate and move toward the first stationary iron core 411.

In some embodiments of the present disclosure, the direction of the main circuit current of the miniature circuit breaker 100 is from one stationary contact 22 to the corresponding movable contact 21, and then from the other movable contact 21 to the corresponding other stationary contact 22. For example, in the examples of FIGS. 1 and 2, the direction of the electric arc between the left stationary contact 22 and the movable contact 21 is opposite to the direction of the electric arc between the right stationary contact 22 and the movable contact 21. Under the action of the second magnetic circuit, the electric arc generated when the movable contacts 21 and the stationary contacts 22 are separated is subjected to a Lorentz force, so that it is pulled away from the space between the movable contacts 21 and the stationary contacts 22 and moves rapidly into the arc extinguishing chamber 30.

For example, in the example of FIG. 6, the direction of the main circuit current can refer to the dotted line with an arrow in FIG. 6 (e.g., the current is marked as I), the two magnetic loops generated by electromagnetic induction can refer to the two closed curves in FIG. 6, and the magnetic field direction of the magnetic loops can be determined according to the right-hand rule. Thus, the Lorentz force F on the electric arc is along the first direction D1, so that the electric arc is driven to move rapidly into the arc extinguishing chamber, and the direction of the Lorentz force F can be determined according to the left-hand rule. Of course, this is only exemplary and does not limit the embodiments of the present disclosure. For example, the direction of the main circuit current may also be opposite to that shown in FIG. 6, which will not be exhausted and described in detail here.

In some examples, the arc extinguishing chamber 30 includes N arc extinguishing grids, where N is an integer and 6≤N≤30. Because the embodiments of the present disclosure do not use a thermal trip unit deformed by temperature rise, the miniature circuit breaker can have a larger arc extinguishing chamber, providing good arc extinguishing performance and achieving a higher arc voltage, thus improving the breaking performance of the miniature circuit breaker.

For example, as shown in FIGS. 1-5, each arc extinguishing sub-chamber 31 includes a plurality of arc extinguishing grids 311, the plurality of arc extinguishing grids 311 are arranged at intervals from each other in the first direction D1 and extend in a sheet shape in the second direction D2 and the third direction D3, and the third direction D3 is perpendicular to the first direction D1 and the second direction D2. In this way, the miniature circuit breaker of the embodiments of the present disclosure not only has excellent and reliable performance, but also has a small product volume and a low product height.

Optionally, the number of arc extinguishing grids arranged in the arc extinguishing chamber 30 is 12~30. For example, as shown in FIGS. 1 and 2, each of the two arc extinguishing sub-chambers 31 is provided with 12 arc extinguishing grids 311, so the entire arc extinguishing chamber 30 is provided with 24 arc extinguishing grids 311. In this way, the arc extinguishing chamber of the embodiments of the present disclosure has a large space and more arranged arc extinguishing grids, for example, it can reach 1.5~3 times the number of arc extinguishing grids of the existing miniature circuit breaker. The present disclosure has good arc extinguishing performance, increased arc voltage, and the miniature circuit breaker has excellent current limiting capability and high short-circuit breaking performance.

For example, as shown in FIGS. 1 and 4, the miniature circuit breaker 100 further includes a conductive connector 80, where the conductive connector 80 is arranged between the two arc extinguishing sub-chambers 31, and is used for connecting the two arc extinguishing sub-chambers 31 and providing an accommodating space for the lower end of the movable contact support 20 when the movable contact support 20 moves downward.

For example, as shown in FIGS. 1 and 2, the miniature circuit breaker 100 further includes an operating mechanism 50, where the operating mechanism 50 is operatively connected to the movable contact support 10 and can drive the movable contact support 10 to move, so that the movable contacts 21 are separated from or in contact with the stationary contacts 22. For example, the operating mechanism 50 may be a manual operating mechanism, and the contact or separation between the movable contacts and the stationary contacts in the miniature circuit breaker 100 is realized by operating a handle 53.

In some embodiments of the present disclosure, when the current of the main circuit of the miniature circuit breaker 100 is large, a large electric repulsion force is generated between the two groups of movable contacts 21 and stationary contacts 22, and under the action of the electric repulsion force, the movable contacts 21 can also be separated from the stationary contacts 22, thereby driving the contact support 10 to move downward.

For example, as shown in FIGS. 1-7, the operating mechanism 50 includes a trip bar 51. The movable contact support 10 includes a support main body 11 extending in the second direction D2, and the support main body 11 has a first end 11A and a second end 11B opposite to each other in the second direction D2. The movable contact support 10 is configured to be movable along the second direction D2, and the movable contacts 21 are connected to the second end 11B of the support main body 11. The first end 11A of the support main body 11 is operatively linked with the trip bar 51 to enable the trip bar 51 to rotate and move away from the support main body 11. Thus, the miniature circuit breaker realizes mechanism tripping, and the trip bar 51 moves away from the support main body 11 and drives the operating mechanism 50 to be in a tripping movement state, that is, to realize the opening and tripping action of the operating mechanism 50, preventing the miniature circuit breaker 100 from being closed continuously in a fault state, thereby realizing the tripping of the miniature circuit breaker 100. The embodiments of the present disclosure do not limit the specific structure of the operating mechanism 50, which may refer to the operating mechanism in the related art as long as the purpose of the present disclosure can be achieved, and will not be described in detail here.

The movable contact support of the embodiment of the present disclosure can perform a linear motion in the first direction, the motion is very simple, the mechanism tripping is simple and fast, the transmission is reliable, the movable contacts can be opened earlier and faster, and the sensitivity and accuracy of tripping are improved.

In some examples, when a short-circuit current occurs, driven by the movable iron core 413 of the magnetic trip assembly 40 and/or under the action of the electric repulsion force between the two groups of movable contacts 21 and stationary contacts 22, the movable contacts 21 of the embodiments of the present disclosure can be separated from the corresponding stationary contacts earlier and faster.

For example, as shown in FIGS. 1-3, the miniature circuit breaker 100 further includes a contact pressure spring 12, one end of the contact pressure spring 12 (e.g., denoted as the first end 12a of the contact pressure spring 12) is connected to the movable contact support 10, the other end of the contact pressure spring 12 (e.g., denoted as the second end 12b of the contact pressure spring 12) is connected to the operating mechanism 50, and the contact pressure spring 12 forms an overtravel gap with the first end 11A of the movable contact support 10.

The embodiments of the present disclosure form an overtravel gap by arranging the contact pressure spring, so that the reliable contact between the movable contacts and the stationary contacts can still be ensured after the contacts are ablated and worn.

In some examples, the number of contact pressure springs 12 is two, and the two contact pressure springs 12 are respectively located on two sides of the support main body 11 in the first direction D1. Of course, this is only exemplary and does not limit the embodiments of the present disclosure.

For example, as shown in FIGS. 1-7, the operating mechanism 5 of the miniature circuit breaker 100 further includes a support member 52. The support member 52 can drive the movable contact support 10 to move downward when the handle 53 is manually operated, so that the movable contacts 21 are separated from the stationary contacts 22. For example, the first end 12a of each contact pressure spring 12 is hooked onto a support post 113 of the support main body 11, and the second end 12b is hooked onto a support post 521 of the support member 52. Exemplarily, when the miniature circuit breaker 100 opens the contacts by operating the handle 53, the support member 52 of the operating mechanism 50 moves and first travels through the overtravel gap, and then drives the movable contact support 10 to move downward, thereby realizing the separation of the movable contacts 21 from the stationary contacts 22.

For example, as shown in FIGS. 1-7, the movable iron core 413 includes a pivot end 413A rotatably connected to the first stationary contact conductor 71, and a free movable end 413B for driving the movable contact support 10 to move.

The movable iron core 413 of the embodiment of the present disclosure can rotate, and drive the movable contact support 10 to move downward when moving toward the first stationary contact conductor 71 and the first stationary iron core 411, so that the movable contacts 21 are separated from the stationary contacts 22.

The clapper-type electromagnet of the embodiment of the present disclosure is rotatably connected to the first stationary contact conductor, has a fast response speed, a short movement stroke of the movable iron core, a more compact design, simple assembly and fewer structural parts.

For example, as shown in FIGS. 4-7, a side surface of the support main body 11 of the movable contact support 10 is provided with a through channel 111 extending in the second direction D2, the through direction of the through channel 111 is along the first direction D1, and the through channel 111 is configured to allow the free movable end 413B of the movable iron core 413 to be inserted therein, so that the free movable end 413B of the movable iron core 413, when driven to move toward the first stationary iron core 411, strikes the movable contact support 10 to move.

In some examples, when the movable contact support 10 is triggered to move by the operating mechanism 50 to open the movable contacts 21, or when the movable contact support 10 is first driven to move by electric repulsion force (for example, when the main circuit current is particularly large, such as reaching 10 KA, 20 KA or 50 KA), the clapper-type electromagnet 41 does not affect the movement of the movable contact support 10 due to the existence of the through channel 111 of the movable contact support 10, and when the movable contact support 10 is first driven by the magnetic trip assembly 40 (for example, when the main circuit current is 1 KA or 2 KA, the electric repulsion force is insufficient to repel the movable contacts and drive the movable contact support 10 to move), the movable iron core 413 of the clapper-type electromagnet 41 can stably and reliably strike the movable contact support 10 to move downward.

Through the ingenious cooperation between the movable iron core of the clapper-type electromagnet and the movable contact support, the embodiments of the present disclosure ensure that the movable contact support can act accurately and stably under various conditions, realize the reliable separation of the movable contacts, the movable contacts can be opened earlier and faster, and the product has a wider application range.

For example, as shown in FIGS. 2-7, the first end 11A of the movable contact support 10 includes a hook-shaped portion 101, the hook-shaped portion 101 protrudes relative to a side surface 112 of the support main body 11, and a hook opening of the hook-shaped portion 101 faces the second end 11B of the support main body 11. The trip bar 51 includes a hooked end 511, and the hooked end 511 and the hook-shaped portion 101 are configured such that, when the movable contacts 21 are in contact with the stationary contacts 22, projections of he hooked end 511 and the hook-shaped portion 101 on a plane formed by the first direction D1 and a third direction D3 overlap at least partially, so that the hooked end 511 of the trip bar 51 may be hooked by the hook-shaped portion 101 when the support main body 11 moves, thereby making the trip bar 51 move away from the support main body 11, where the third direction D3 is perpendicular to the first direction D1 and the second direction D2.

The embodiments of the present disclosure realize the linkage between the movable contact support and the trip bar through the cooperation of a simple hook design, the mechanism tripping is simple and fast, and the movable contacts can be opened earlier and faster.

For example, as shown in FIG. 1, the miniature circuit breaker 100 further includes a second stationary iron core 43. The first stationary contact conductor 71 extends from the first terminal 61 around the first stationary iron core 411 to a corresponding arc extinguishing sub-chamber 31 in the arc extinguishing chamber 30. The second stationary contact conductor 72 surrounds an outer side of the second stationary iron core 43, where the second stationary contact conductor 72 extends from the second terminal 62 around the second stationary iron core 43 to a corresponding arc extinguishing sub-chamber 31 in the arc extinguishing chamber 30. The first stationary iron core 411 and the second stationary iron core 43 are located on two sides of the movable contact support 10 in the first direction D1, and the first stationary contact conductor 71 and the second stationary contact conductor 72 are respectively located on two sides of the movable contact support 10 in the first direction D1.

The embodiments of the present disclosure realize the double breaking point and double arc extinguishing chamber design of the miniature circuit breaker through the symmetrical structure on both sides of the movable contact support, which increases the arc voltage and improves the breaking capacity.

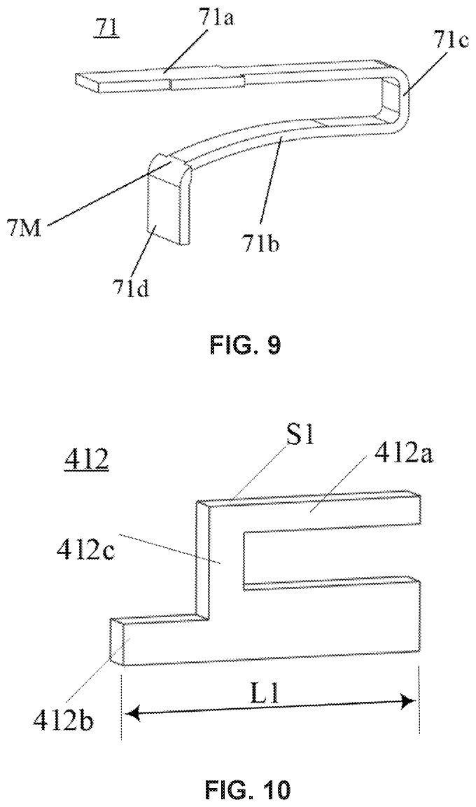

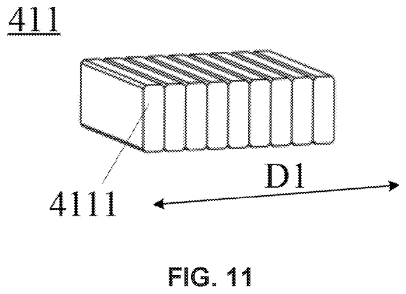

FIG. 8 is a structural schematic diagram of a movable iron core according to some embodiments of the present disclosure. FIG. 9 is a structural schematic diagram of a first stationary contact conductor according to some embodiments of the present disclosure. FIG. 10 is a structural schematic diagram of a first magnetic conductive block according to some embodiments of the present disclosure. FIG. 11 is a structural schematic diagram of a first stationary iron core according to some embodiments of the present disclosure.

For example, as shown in FIGS. 1, 3 and 9, the first stationary contact conductor 71 includes a U-shaped conductive plate wound around the first stationary iron core 411, the U-shaped conductive plate includes a first conductor segment 71a, a second conductor segment 71b and an intermediate conductor segment 71c connecting the first conductor segment 71a and the second conductor segment 71b. The first conductor segment 71a and the second conductor segment 71b are respectively located on two sides of the first stationary iron core 411 in the second direction D2, and an opening direction of the U-shaped conductive plate faces away from the movable contact support 10.

The embodiments of the present disclosure feed current through a U-shaped conductive plate designed, which can not only form a main circuit and generate two magnetic loops, but also has a simple structure, a small number of parts and convenient assembly.

For example, as shown in FIGS. 3-5, the pivot end 413A of the movable iron core 413 forms a rotational connection with the first conductor segment 71a of the first stationary contact conductor 71 by a connecting shaft (not shown), the corresponding stationary contact 22 is arranged on the second conductor segment 71b of the first stationary contact conductor 71, and a tail end 7M of the second conductor segment 71b of the first stationary contact conductor 71 away from the movable contact support 10 corresponds to an outer end of the arc extinguishing sub-chamber 31.

For example, as shown in FIG. 8, an iron core main body 4131 of the movable iron core 413 is plate-shaped, an end of the iron core main body 4131 close to the movable contact support 10 is the free movable end 413B, an end of the iron core main body 4131 away from the movable contact support 10 is the pivot end 413A, the pivot end 413A of the movable iron core 413 has two connecting pieces 401, and the two connecting pieces 401 are respectively located on two sides of the first conductor segment 71a of the first stationary contact conductor 71 in the third direction D3. Each connecting piece 401 is provided with a through hole 413c, and the connecting shaft may pass through the through holes 413c on these two connecting pieces 401 along the third direction D3. In this way, the pivot end 413A of the movable iron core 413 can be rotatably connected to the first stationary contact conductor 71 through the connecting shaft.

The embodiments of the present disclosure adopt a plate-shaped rotatable movable iron core, which can not only effectively and stably drive the movable contact support to perform linear motion, but also is convenient and fast to assemble and compact in volume.

For example, as shown in FIG. 8, the free movable end 413B of the movable iron core 413 is an extension post 403 whose width (width in the third direction D3) is less than a main body width of the iron core main body 4131. For example, as shown in FIG. 8, a slot 402 may also be provided on the iron core main body 4131 of the movable iron core 413 for avoiding other related parts to prevent interference.

In some examples, the clapper-type electromagnet 41 further includes a return spring (not shown). After the movable iron core 413 moves and strikes the movable contact support 10 to move to realize the separation of the movable contacts 21 from the stationary contacts 22, the movable iron core 413 is returned to an initial position by the return spring, that is, the movable iron core 413 rotates and moves away from the first stationary contact conductor 71 to return to the initial position.

For example, as shown in FIGS. 3 and 9, the first stationary contact conductor 71 further includes a third conductor segment 71d connected to the tail end 7M of the second conductor segment 71b, and the third conductor segment 71d extends from the tail end 7M of the second conductor segment 71b to the arc extinguishing sub-chamber 31 and the third conductor segment 71d integrally extends in the second direction D2.

The stationary contact conductor with a specific structural design in the embodiments of the present disclosure can not only generate two magnetic loops, but also help guide the electric arc from the contacts to the arc extinguishing chamber.

In some examples, the first conductor segment 71a is a straight bar extending in the first direction D1. In this way, the first conductor segment 71a has lower resistance and conductor heating is not severe.

In some examples, the first stationary contact conductor 71 and/or the second stationary contact conductor 72 are respectively integrally formed. For example, as shown in FIGS. 1-3, the first stationary contact conductor 71 and the second stationary contact conductor 72 have the same structure. In some embodiments of the present disclosure, the first stationary contact conductor 71 and the second stationary contact conductor 72 having the same structure means that the second stationary contact conductor 72 is also a U-shaped conductive plate formed by a plurality of conductor segments, but it is not limited that the first stationary contact conductor 71 and the second stationary contact conductor 72 must be the identical in size, shape details and the like. For the clarity and conciseness of this document, the structure of the second stationary contact conductor 72 will not be described in detail here, and reference may be made to the above description of the second stationary contact conductor 72.

For example, as shown in FIGS. 1-2, 4-5 and 10, the clapper-type electromagnet 41 further includes two first magnetic conductive blocks 412, and the two first magnetic conductive blocks 412 are respectively located on two sides of the first stationary contact conductor 71 in the third direction D3. Each first magnetic conductive block 412 includes a first magnetic conductive segment 412a, a second magnetic conductive segment 412b and an intermediate magnetic conductive segment 412c connecting the first magnetic conductive segment 412a and the second magnetic conductive segment 412b. The first magnetic conductive segment 412a and the second magnetic conductive segment 412b both extend in the first direction D1, and the intermediate magnetic conductive segment 412c is located at an end of the first magnetic conductive block 412 away from the movable contact support 10 in the first direction D1. The first magnetic conductive segment 412a is attached to an end of the first stationary iron core 411 away from the arc extinguishing chamber 30 in the second direction D2, and the second magnetic conductive segment 412b is attached to an end of the first stationary iron core 411 close to the arc extinguishing chamber 30 in the second direction D2.

The clapper-type electromagnet according to the embodiments of the present disclosure, by arranging two first magnetic conductive blocks, provides a low magnetic reluctance path, forming a closed magnetic loop around the first stationary iron core. The magnetic field force of the clapper-type electromagnet is greater, which is beneficial for improving the breaking capacity of the miniature circuit breaker.

For example, as shown in FIGS. 1 and 10, a length L1 of the second magnetic conductive segment 412b in the first direction D1 covers the corresponding arc extinguishing sub-chamber 31. In this way, the first magnetic conductive block of the clapper-type electromagnet 41 can cover the entire path of arc extinguishing, the arc extinguishing performance is better, and the breaking performance of the miniature circuit breaker is improved.

For example, when the movable iron core 413 is driven to move downward, it will move until the movable iron core 413 claps against the surface S1 of each first magnetic conductive segment 412a at the end away from the first stationary contact conductor 71 in the second direction D2. The embodiments of the present disclosure not only play a role of magnetic conduction by arranging the first magnetic conductive block, but also can well cooperate with the clapping movement of the movable iron core, with a simple structure and fewer required parts.

In some examples, the first magnetic conductive block 412 may be integrally formed. Of course, this is only exemplary and does not limit the embodiments of the present disclosure.

For example, as shown in FIGS. 2 and 9, the first stationary iron core 411 includes a plurality of separate iron core blocks 4111 arranged side by side in the first direction D1; and/or the second stationary iron core 43 includes a plurality of separate iron core blocks 4111 arranged side by side in the first direction D1. For example, the plurality of separate iron core blocks 4111 may be in contact with each other or arranged with gaps in the first direction D1, which is not limited in the embodiments of the present disclosure and can be determined according to actual needs.

The embodiments of the present disclosure form the stationary iron core by adopting a plurality of separate iron core block units, which can not only form a magnetic circuit meeting the requirements, but also be better applicable to a miniature circuit breaker with high breaking capacity, the magnetic field distribution is more flexible, and the heating degree of the iron core can be reduced.

For example, as shown in FIGS. 1 and 2, the miniature circuit breaker 100 further includes two second magnetic conductive blocks 44, and the two second magnetic conductive blocks 44 are respectively located on two sides of the second stationary contact conductor 72 in the third direction D3. For example, the second magnetic conductive block 44 and the first magnetic conductive block 412 have the same structure.

In some embodiments of the present disclosure, the second magnetic conductive block 44 and the first magnetic conductive block 412 having the same structure means that the second magnetic conductive blocks 44 are also formed by a plurality of similar magnetic conductive segments and the positional relationship between each magnetic conductive segment and the second stationary iron core 43 is similar, but it is not limited that the second magnetic conductive blocks 44 and the first magnetic conductive blocks 412 must be the identical in size, shape details and the like. For the clarity and conciseness of this document, the structure and technical effects of the second magnetic conductive blocks 44 will not be described in detail here, and reference may be made to the above description of the first magnetic conductive blocks 412.

In some embodiments of the present disclosure, the magnetic field formed by the second stationary iron core 43, the second stationary contact conductor 72 and the second magnetic conductive blocks 44 can also drive the electric arc to move toward the arc extinguishing sub-chamber 31 corresponding to the second stationary contact conductor 72. For the relevant content of the magnetic field formed by the second stationary iron core 43, the second stationary contact conductor 72 and the second magnetic conductive blocks 44 and the relevant content of the electric arc being subjected to the Lorentz force in the embodiments of the present disclosure, reference may be made to the above description of the first stationary contact conductor 71, the first stationary iron core 411 and the first magnetic conductive blocks 412, which will not be described in detail here.

In some examples, a total weight of the movable contact support 10 and the two movable contacts 21 is 2 g~2.5 g. The size and weight of the movable contacts and stationary contacts of the embodiments of the present disclosure can be reduced, which not only helps to reduce the contact pressure between the movable contacts and the stationary contacts, but also helps to reduce the weight of the entire miniature circuit breaker. When it is necessary to break the current, the movable contacts with small mass and bearing lower contact pressure can be opened earlier and faster to move away from the stationary contacts.

In some embodiments of the present disclosure, for example, when a short circuit with an expected short-circuit current as high as 50kA occurs, the short-circuit current passing through the miniature circuit breaker 100 provided by the embodiments of the present disclosure can quickly repel the two movable contacts 21 and the corresponding stationary contacts 22. Simultaneously, the clapper-type electromagnet 41 of the magnetic trip assembly 40 also quickly drives the movable contact support 10 to move linearly downward. Combined with favorable factors such as the small mass of the movable contacts 21 and/or the movable contact support 10, a very high short-circuit current can be limited within a very short time (for example, the movable and stationary contacts are separated within 1 ms, and the short-circuit current is limited to below 10 kA) and then the electric arc is quickly extinguished (for example, within 2 ms). The embodiments of the present disclosure can trip instantaneously when a high short-circuit current occurs, so that the miniature circuit breaker 100 can achieve a better breaking effect, reduce power consumption, and control the cost within an appropriate range.

It should be noted that the drawings of the embodiments of the present disclosure only relate to the structures involved in the embodiments of the present disclosure, and other structures can refer to the usual design. It should be understood that the above description is intended to be illustrative rather than restrictive. For example, the above embodiments (and/or aspects thereof) can be used in combination with each other. In addition, many modifications can be made to adapt a particular situation or material to the teachings of the present disclosure without departing from the scope of the present disclosure. The functions or performances of the various elements or modules described herein are for illustration only and are in no way limiting, but merely exemplary embodiments. After reading the above description, many other embodiments and modifications within the spirit and scope of the claims will be apparent to those skilled in the art. Therefore, the scope of the present disclosure should be determined with reference to the appended claims and the full scope of equivalents to which those claims are entitled.

1. A miniature circuit breaker, comprising:
a contact system, comprising a movable contact support and two contact groups, wherein each of the two contact groups comprises a movable contact and a stationary contact, two movable contacts are arranged at intervals in a first direction and mounted on the movable contact support, and the movable contact support is configured to be movable in a second direction perpendicular to the first direction to make the movable contact contact with or separate from a corresponding stationary contact;
a conductor group, comprising a first stationary contact conductor and a second stationary contact conductor, wherein the stationary contact of one of the two contact groups is arranged on the first stationary contact conductor, and the stationary contact of the other one of the two contact groups is arranged on the second stationary contact conductor;
an arc extinguishing chamber configured to extinguish an electric arc generated by the two contact groups;
a magnetic trip assembly, comprising a first stationary iron core and a movable iron core that form a clapper-type electromagnet with the first stationary contact conductor, wherein the first stationary contact conductor surrounds an outer side of the first stationary iron core, and the first stationary contact conductor is configured to form a first magnetic circuit and a second magnetic circuit with the first stationary iron core based on a current flowing through the first stationary contact conductor; when the current exceeds a threshold current, the movable iron core is driven by the first magnetic circuit and moves toward the first stationary iron core to drive the movable contact support to move; and the second magnetic circuit is configured to drive the electric arc to move toward the arc extinguishing chamber.

2. The miniature circuit breaker according to claim 1, wherein the arc extinguishing chamber comprises two arc extinguishing sub-chambers, the two arc extinguishing sub-chambers are respectively located on two sides of the contact system in the first direction, each of the two arc extinguishing sub-chambers is configured to extinguish the electric arc generated by a corresponding contact group, and the second magnetic circuit is configured to drive the electric arc to move toward an arc extinguishing sub-chamber corresponding to the first stationary contact conductor.

3. The miniature circuit breaker according to claim 2, wherein each of the two arc extinguishing sub-chambers comprises a plurality of arc extinguishing grids, the plurality of arc extinguishing grids are arranged at intervals from each other in the first direction and extend in a sheet shape in the second direction and a third direction, and the third direction is perpendicular to the first direction and the second direction.

4. The miniature circuit breaker according to claim 1, wherein the arc extinguishing chamber comprises N arc extinguishing grids, where N is an integer and 6≤N≤30.

5. The miniature circuit breaker according to claim 2, further comprising an operating mechanism,
wherein the operating mechanism comprises a trip bar, the movable contact support comprises a support main body extending in the second direction, the support main body has a first end and a second end opposite to each other in the second direction, the movable contact support is configured to be movable along the second direction, and the movable contact is connected to the second end of the support main body, the first end of the support main body is operatively linked with the trip bar to enable the trip bar to rotate and move away from the support main body.

6. The miniature circuit breaker according to claim 5, wherein the movable iron core comprises: a pivot end rotatably connected to the first stationary contact conductor, and a free movable end for driving the movable contact support to move; and
a side surface of the support main body is provided with a through channel extending in the second direction, a through direction of the through channel is along the first direction, and the through channel is configured to allow the free movable end to be inserted therein, so that the free movable end, when driven to move toward the first stationary iron core, strikes the movable contact support to move.

7. The miniature circuit breaker according to claim 5, wherein the first end of the movable contact support comprises a hook-shaped portion, the hook-shaped portion protrudes relative to a side surface of the support main body, and a hook opening of the hook-shaped portion faces the second end of the support main body ; and
the trip bar comprises a hooked end, and the hooked end and the hook-shaped portion are configured such that, when the movable contact is in contact with the stationary contact, projections of he hooked end and the hook-shaped portion on a plane formed by the first direction and a third direction overlap at least partially, so that the hooked end is hooked by the hook-shaped portion when the support main body moves, thereby making the trip bar move away from the support main body, wherein the third direction is perpendicular to the first direction and the second direction.

8. The miniature circuit breaker according to claim 6, further comprising a second stationary iron core, a first terminal and a second terminal, wherein one of the first terminal and the second terminal is an incoming terminal and the other one is an outgoing terminal,
the first stationary contact conductor extends from the first terminal around the first stationary iron core to a corresponding arc extinguishing sub-chamber in the arc extinguishing chamber,
the second stationary contact conductor surrounds an outer side of the second stationary iron core, wherein the second stationary contact conductor extends from the second terminal around the second stationary iron core to a corresponding arc extinguishing sub-chamber in the arc extinguishing chamber, and
the first stationary iron core and the second stationary iron core are located on two sides of the movable contact support in the first direction, and the first stationary contact conductor and the second stationary contact conductor are respectively located on two sides of the movable contact support in the first direction.

9. The miniature circuit breaker according to claim 8, wherein
the first stationary contact conductor comprises a U-shaped conductive plate wound around the first stationary iron core, the U-shaped conductive plate comprises: a first conductor segment, a second conductor segment and an intermediate conductor segment connecting the first conductor segment and the second conductor segment, the first conductor segment and the second conductor segment are respectively located on two sides of the first stationary iron core in the second direction, and an opening direction of the U-shaped conductive plate faces away from the movable contact support ; and
the pivot end is rotatably connected to the first conductor segment by a connecting shaft, the stationary contact is arranged on the second conductor segment, and a tail end of the second conductor segment away from the movable contact support corresponds to an outer end of the arc extinguishing sub-chamber.

10. The miniature circuit breaker according to claim 9, wherein the first stationary contact conductor further comprises a third conductor segment connected to the tail end of the second conductor segment, and the third conductor segment extends from the tail end to the arc extinguishing sub-chamber and integrally extends along the second direction.

11. The miniature circuit breaker according to claim 9, wherein the first conductor segment is a straight bar extending in the first direction.

12. The miniature circuit breaker according to claim 8, wherein
the first stationary contact conductor and/or the second stationary contact conductor are respectively integrally formed, and the first stationary contact conductor and the second stationary contact conductor have the same structure.

13. The miniature circuit breaker according to claim 8, wherein the first stationary iron core comprises a plurality of separate iron core blocks arranged side by side in the first direction ; and/or
the second stationary iron core comprises a plurality of separate iron core blocks arranged side by side in the first direction.

14. The miniature circuit breaker 0) according to claim 1, wherein
the clapper-type electromagnet further comprises two first magnetic conductive blocks, the two first magnetic conductive blocks are respectively located on two sides of the first stationary contact conductor in a third direction, wherein the third direction is perpendicular to the first direction and the second direction ;
each of the two first magnetic conductive block comprises a first magnetic conductive segment, a second magnetic conductive segment and an intermediate magnetic conductive segment connecting the first magnetic conductive segment and the second magnetic conductive segment, wherein the first magnetic conductive segment and the second magnetic conductive segment both extend in the first direction, and the intermediate magnetic conductive segment is located at an end of the first magnetic conductive block away from the movable contact support in the first direction ; and
the first magnetic conductive segment is attached to an end of the first stationary iron core away from the arc extinguishing chamber in the second direction, and the second magnetic conductive segment is attached to an end of the first stationary iron core close to the arc extinguishing chamber in the second direction.

15. The miniature circuit breaker according to claim 14, wherein a length of the second magnetic conductive segment in the first direction covers a corresponding arc extinguishing sub-chamber.

16. The miniature circuit breaker according to claim 14, further comprising two second magnetic conductive blocks, wherein the two second magnetic conductive blocks are respectively located on two sides of the second stationary contact conductor in the third direction, and each of the two second magnetic conductive blocks and each of the two first magnetic conductive blocks have the same structure.

17. The miniature circuit breaker according to claim 1, wherein a total weight of the movable contact support and the two movable contacts is 2 g to 2.5 g.

18. The miniature circuit breaker according to claim 5, further comprising a contact pressure spring, wherein one end of the contact pressure spring is connected to the movable contact support, the other end of the contact pressure spring is connected to the operating mechanism, and the contact pressure spring forms an overtravel gap with the first end of the movable contact support.

19. The miniature circuit breaker according to claim 1, further comprising an electronic trip unit, wherein the electronic trip unit is configured to control movement of the movable contact support by sensing a current of the second stationary contact conductor to trigger tripping of the miniature circuit breaker.
